(19) United States
(12) Patent Application Publication
(10) Pub. No.: US 2003/0125931 A1
(43) Pub. Date: Jul. 3, 2003

(54) Method for matching strings

(76) Inventor: Shannon Roy Campbell, Westminster, CA (US)

Correspondence Address: Shannon R. Campbell, 14561 Colonial Dr., Westminster, CA, 92683, US

(21) Appl. No.: 10/314,113

(22) Filed: Feb. 25, 2003

Related U.S. Application Data
(60) Provisional application No. 60/339,226, filed on Dec. 7, 2001.

(51) Int. Cl. G06F 17/21

(52) U.S. Cl. 704/10

(57) ABSTRACT

A method for efficient and quick string matching is presented. The algorithm gains its efficiency through the assumption that the text to be searched is large and that the pattern searched for is also somewhat large. A preprocessing step is performed on the text and the pattern that consists of finding the locations of matches with a small patch of characters that occurs commonly in both the text and pattern. The distances between successive small patch matching locations (called interdistances) are stored as lists. Based on comparison of the interdistance lists, the probability of match can be calculated. The method is fast because the interdistance lists are much smaller than the text and pattern data and comparing these two smaller lists is significantly faster than comparing the text and pattern data using existing algorithms.

### CROSS-REFERENCE TO RELATED APPLICATIONS

Not applicable.

### STATEMENT REGARDING FEDERALLY SPONSORED RESEARCH OR DEVELOPMENT

The material covered in this patent is not the result of federally sponsored research or development.

### REFERENCE TO A MICROFICHE APPENDIX

Not applicable.

### BACKGROUND OF THE INVENTION

This patent relates to the fields of string matching, bioinformatics, internet searches, text queries, and pattern recognition.

### REFERENCES CITED

6,169,969 Jan. 2, 2001 Cohen 704/10

D. Gusfield, Algorithms on strings, trees, and sequences: computer science and computational biology. Cambridge University Press, New York, N.Y., 1997.

D. Sankoff, J. Kruskal, Time warps, string edits, and macromolecules, The theory and practice of sequence comparison, 2^{nd} Ed. Addison-Wesley, London, 1999.

S. F. Altschul, W. Gish, W. Miller, E. W. Myers, and D. J. Lipman. A basic local alignment search tool. Journal of Molecular Biology, 215, 403-410, 1990.

S. F. Altschul, T. L. Madden, A. A. Schaffer, J. Zhang, Z. Zhang, W. Miller, and D. J. Lipman, Gapped BLAST and PSI-BLAST: a new generation of protein database search programs, Nucleic Acids Res. 25, 3389-3402, 1997.

Much work has been done in string matching due to its relevance for searching databases, searching the web, and analyzing genetic information. Most algorithms are based on searching for a match by marching along the text one character at a time. Advances and increases in efficiency exist that make use of skipping several characters ahead when mismatches make matching impossible and several comparisons are therefore unnecessary (see a recent book on the subject by Gusfield, 1997, and Sankoff and Kruskal, 1999). Also, the most widely used algorithm for DNA searches is BLAST (basic local alignment search tool) and this algorithm approximates a dynamic programming method for alignment of a pattern with text (see Atschul et al 1990, and Atschul et al 1997). Our algorithm is different because it uses a preprocessing step to help find relationships among particular subsequences within the pattern. This is the basic concept of our method and the resulting search time is much less than linear. Our algorithm makes use of relationships among features within the string, and is therefore different from any algorithms that make use of hash tables, such as Cohen U.S. Pat. No. 6,169,969 entitled “Device and method for full-text large-dictionary string matching using n-gram hashing”.

### BRIEF SUMMARY OF THE INVENTION

The method of match relies upon a preprocessing step. The preprocessing step consists of choosing a small template containing several characters from the alphabet and performing an exact search for this small template in both the pattern and the text. This preprocessing step need only be performed once for the text. We calculate and store the distances between successive matches with the small template, called the interdistances. The lists of the interdistances are then compared and estimates of the probability of match can be made. Because the lists of interdistances are much smaller than the text and the pattern, comparing them leads to a fast method of string matching.

### BRIEF DESCRIPTION OF THE SEVERAL VIEWS OF THE DRAWINGS

FIG. 1 is a block diagram of the present invention method.

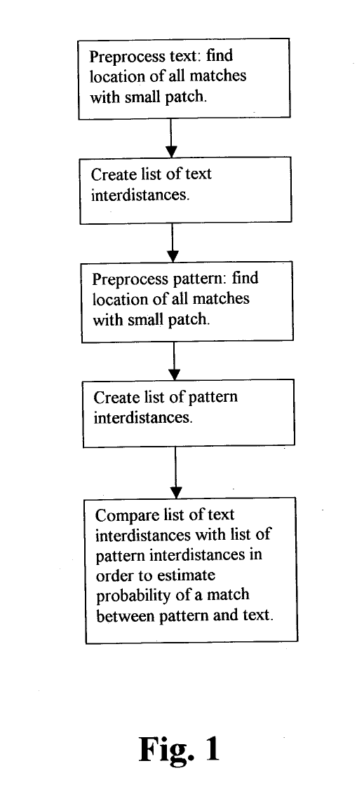

### DETAILED DESCRIPTION OF THE INVENTION

The goal is to perform efficient matching of strings. There are several assumptions that we state now. The first is that the text is large, it may consist of several million or billion characters. The text needs to be preprocessed and the preprocessing step is of order O(ns), where s is a small integer constant and the text is of length n. After the text has been preprocessed, it never needs to be preprocessed again. We assume that the text is frequently searched and that performing this preprocessing step once is practical. The next assumption is that the pattern to be matched, of length m, is also relatively large, of length greater than several hundred characters and this topic is discussed in detail below.

We now provide an example of the method. Assume that we are performing matching of strings consisting of 4 different characters. We will use the labels 1, 2, 3, and 4 for convenience. Following standard terminology, we will refer to the string being searched for as the pattern of length m, and the data we search through as the text of length n.

The preprocessing step is as follows. In the text, search for a small patch of characters of length s. For example, in the following text, we search for the small patch ‘21’ (s=2),

142132431413321224312133231341311242344124324131342144323213413241312243

resulting in the following sequence of matches, ‘1’, and non-matches ‘0’, with the small patch

0010000000000100000100000000000000000000000000000010000001000000000000000

This binary sequence can be represented by the following notation, which we call the reduced representation (11, 6, 31, 7), which represents the distances between successive matches with the small patch. On average the number of matches of the small patch with the text is given by n/(4^{s}), assuming that the each of the four characters occurs with probability of ¼.

The next step is to preprocess the pattern, a step of O(ms). We assume that the pattern of length m is long enough to have several matches with the small patch. This requires that the length of the pattern, m, be at least 4^{s} and should be several times larger so that there is a high probability of obtaining several matches with the small patch.

Let the pattern be, 214432321, then the resulting sequence of matches and non-matches with the small patch is given by the following sequence, 100000010. The reduced representation is then (7).

We now can efficiently perform matching because we need only compare the reduced representations to ensure that the distances between successive small patch matches are identical (or similar) in both the text and pattern. In other words, to find a match we must only search through the reduced representations of both strings. We assume a brute force search for this step. This takes on average nm/(16^{s}) comparisons.

The probability of matching four elements in a string of length n is n/(4⁴). In our algorithm however, we have not only matched four elements, but we have also correctly matched the interdistances, which increases the significance of match. In the given example, the probability of match is

n(¼⁴)(15/16)⁶(⅙)

The above formula can be generalized to p number of small matches, at k specific interdistances given by d(k), and an alphabet of b letters, where the number of elements in the small match is given by s. This results in the following probability of match,

n(1/(p−1)!)(1/b)^{s}Π((1/b)^{s}(1−(1/b)^{s})^{d(k)})/d(k)

where the product symbol means a product over the index k, where k goes from 1 to p−1.

If one ignores the preprocessing stage for the text, the computations required are O(ms) for processing the pattern, and O(nm/(b^{2s})) for determining matches between the two reduced representations. In principle, one only need match a few small segments at the correct interdistances in order to achieve a high degree of match.

The above arguments reveal the probability of a text having an exact match with a pattern. These arguments can readily be extended to calculate the probability of an inexact match.

The above method should find application in bioinformatics, in search engines that search the web for specific strings of text, in creating software to determine whether or not a specific sentence or paragraph has been plagiarized from existing text, and has potential application to speech recognition, recognition of temporal signals, and analysis and comparison of music.

What is claimed is:

1. A method for efficient search of a large library of text to find matches with a pattern comprising the steps of:
a) preprocessing the text by finding the locations of match with a small patch of length s, where s is a small integer;
b) creating a text list containing the distances between sequential locations of match where the small patch is found in the text;
c) preprocessing the pattern by finding the locations of match with the small patch;
d) creating a pattern list containing the distances between sequential locations of match where the small patch is found in the pattern;
e) comparing the text list and the pattern list to determine estimates of the probability that the pattern is contained at locations in the text.
